(19) United States
(12) Patent Application Publication
(10) Pub. No.: US 2005/0093305 A1
(43) Pub. Date: May 5, 2005

(54) Power child safety locking system

(76) Inventor: Gerald Leonard Jackson, Montgomery, AL (US)

Correspondence Address: Gerald Leonard Jackson, 6108 Eric Lane, Montgomery, AL, 36116, US

(21) Appl. No.: 10/697,538

(22) Filed: Oct. 29, 2003

(51) Int. Cl. E05C 3/06

(52) U.S. Cl. 292/216

(57) ABSTRACT

A child safety locking device for use in automobiles and the like which is operatively associated with an electronic controlled activating and deactivating system, allowing the operator of a vehicle to control the inside vehicle rear door opening mechanism.

### CROSS REFERENCE TO RELATED APPLICATIONS

1. Field of the Invention

The present invention relates to an operational system to control child safety locks on automobiles.

2. Description of the Art

The present invention is an operational system for use in automobiles and the like. The operator of the vehicle may engage or disengage the child safety lock mechanism from the comfort of the driver's seat.

U.S. Pat. No. 4,652,768 issued to Gmeiner describes an invention that relates to a locking mechanism for the child safety locks of the rear door of a motor vehicle. However, this system is limited to a positive grounded vehicle. Gmeiner specifically claims the use of a p-n-p (positive-negative-positvie) transitor to regulate the flow of of the electric current. My invention employs the use of a relay switch which will allow my system to work with a n-p-n (negative-positive-negative) grounded vehicle as well as a p-n-p grounded vehicle. All vehicles are not positively grounded. Some are negatively grounded and some are positively grounded. The use of a relay switch will allow the current to flow regardless of whether the vehicle is positively grounded or negatively grounded.

### SUMMARY OF THE INVENTION

It is a principal object of this invention to provide an automated system for engaging and disengaging child safety lock mechanism. Another object of this invention is to provide a display indicating the status of the child safety lock mechanism.

### BRIEF DESCRIPTION OF THE DRAWINGS

FIG. 1 is a top view of an automobile showing the location of the power locking device and child safety lock internally to the doors, and the location of the control switch.

FIG. 2 shows a rocker arm switch for controlling the disposition of the power locks.

FIG. 3 is a perspective view of a suitable arm rest switch location.

FIG. 4 is a outside view of a typical driver's front door.

FIG. 5. is a sectional and schematic view of a child safety lock and solenoid wherein the locking mechanism is disengaged.

FIG. 6. is a sectional and schematic view of the child safety lock mechanism and solenoid wherein the locking mechanism is engaged.

FIG. 7. is a schematic view of an electric circuit, latch and solenoid power operator, indicator switch and light emitting diode (LED) device.

FIG. 8 is a flow chart showing steps and actions taken by an operator and the system.

### DETAILED DESCRIPTION OF THE PREFERRED EMBODIMENT

A feature of the present invention particularly includes, with respect to the use in automobiles, a readout display either on the control switches or on the dashboard of an automobile which alerts the driver, for example, of the status or condition of a particular child safety lock, namely a particular lock would be shown to be either locked or unlocked. Obviously, however, the display may be used with any vehicle in which the system is installed.

The child safety locks on modem automobiles having doors to the rear of the driver's seat involve a special locking mechanism which deactivates the inside door latch operating button or lever, but does not affect the outside door latch operating button or lever, so that a rear door may be opened from the outside, but not opened from the inside. The control lever for setting the safety mechanism is generally located on what may be termed the jamb portion of the door, near the latch, thus being inaccessible to a person from the inside or the outside of a vehicle once the door is closed. A typical design consists of a small lever which may be set in either an up or down position. When set in the down position, the inside door operating mechanism, which allows the door to open and free itself from the door jamb latch is disabled. Currently, in order for a person to disable the safety lock on the rear doors of automobiles, or to simply open the door, he or she must exit the driver's seat, get out of the vehicle and manually open the rear door from the outside in order to allow passengers seated in the rear seats to exit. This is an inconvenience as can be appreciated by the automobile operator who transports children or others who are deemed to require enchanced safety measures to ensure continuance of their health and welfare.

The present invention is directed to an electro-mechanical door safety lock mechanism, operated from the driver's seat, for controlling the child safety locking device on the rear doors of automobiles or the doors of other vehicles. Moreover, the left rear door and right rear door safety locks are, under the provisions of my invention, independently controlled.

Further, the vehicle operator is able, within the provisions of my invention, to activate or deactivate the safety locks while the vehicle is in motion or at rest relative to the ground.

Additionallly, the electronic control system of my invention includes a visual lock status indicator or display to allow the vehicle operator to instantly and easily be aware of the condition or status of each safety lock. This indicator device is positioned within direct view of the operator, preferably within the area commonly known as the dashboard of the automobile. Obviously however, the visual indicator may be included within the swithcing device. For example, the buttons on the control panel may include a light source to indicate when a specific door safety lock is activated or when both door locks are activated.

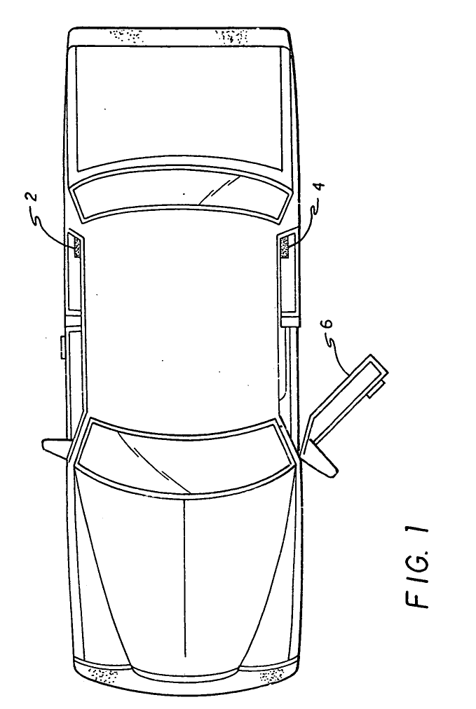

More particularly, and with respect to the drawings, FIG. 1 thus shows the position of the power locks 2 and 4 on the rear doors of an automobile. Further, the position of the operator switch 6 is shown on the right front door.

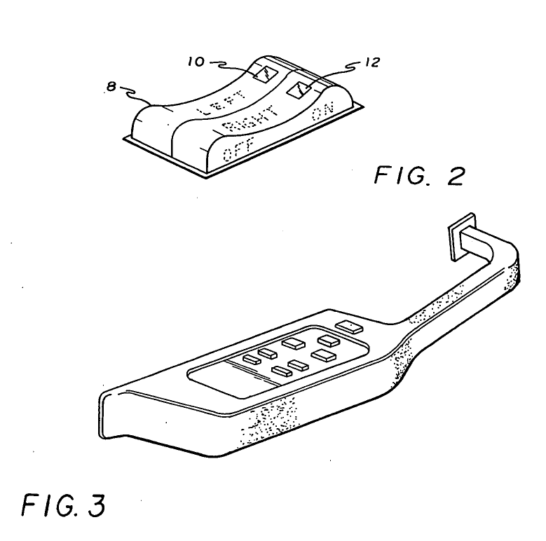

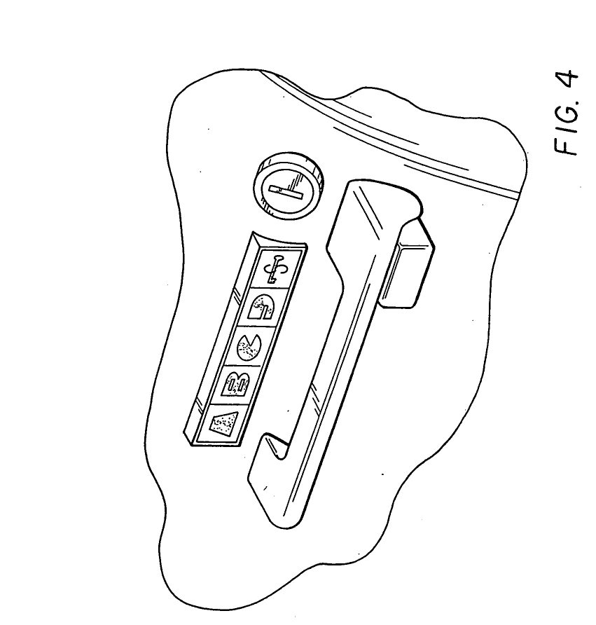

FIG. 2 shows an electric rocker arm switch suitable for mounting on the arm rest, for example, of an automobile door, further showing light emitting diode status indicators 10 and 12 within the switch housings. Further, independent switches 8 located in a single location allow individual locking and unlocking and space design efficiencies.

In regard to the rocker arm switches, if the status of either door is changed from locked to unlocked, or vice versa, a door face lighted indicator changes from a light emitting state to a light non-emitting state. An additional feature of the rocker arm switches lies in a design having positive tactile depressions to allow an operator to feel the position of the switches.

FIG. 3 illustrates a possible door arm structure and location for the control switches.

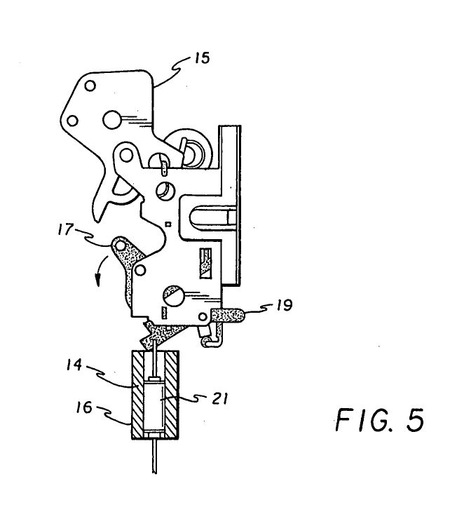

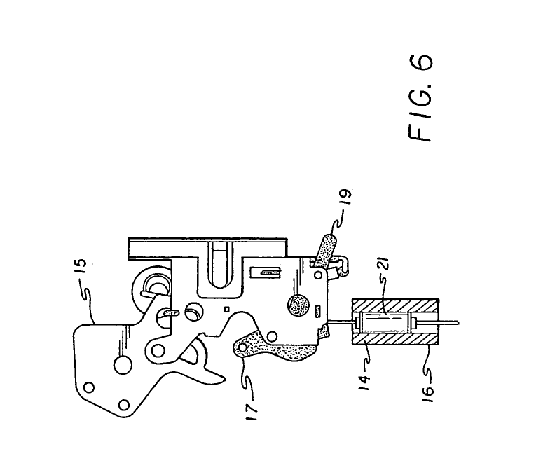

FIG. 5 shows the combination of a power locking device, namely a solenoid, and a child safety lock wherein the power lock is in the disengaged position, or downward position. Linkage 17 is directly attached to the inside door handle and moves in the direction indicated by the arrow when an attempt is made to open the door.

FIG. 6 shows the combination of a power locking device and a child safety lock wherein the power device, solenoid core 21, is in the disengaged position, or upward position.

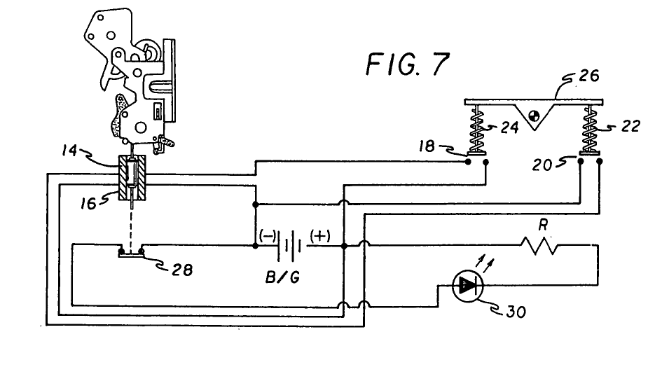

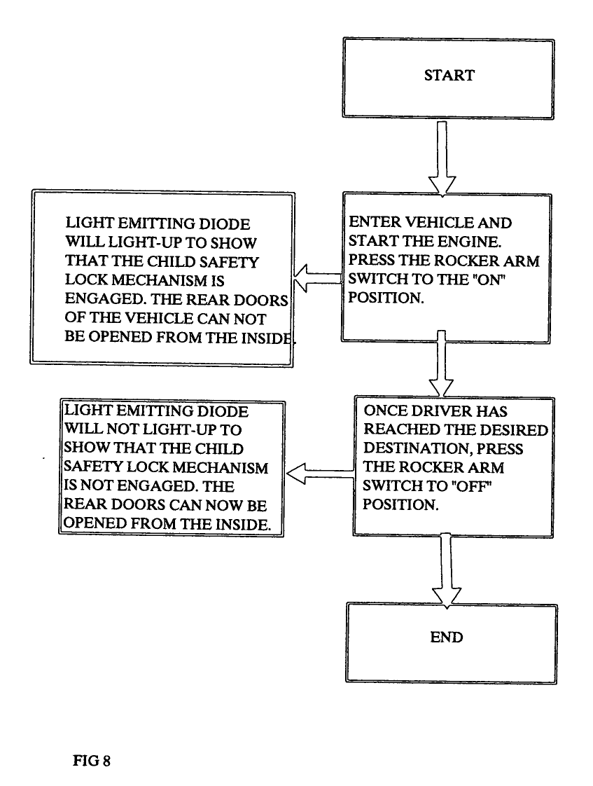

Turning now to the electric and mechanical arrangements involved in my invention, FIG. 7 illustrates an operational electrical circuit and associated mechanical system for controlling the condition of a child safety lock. A power source B/G, for example, the battery or generator/alternator of an automobile supplies a d.c. current to the circuit, which includes rocker arm switches 18 and 20, attached to rocker arm 26. These switches are double pole single throw types. The switches are provided with springs 22 and 24 to allow for only an intermittent and temporary circuit-making contact. FIG. 7 depicts a condition wherein the power locking device is engaged and the indicator switch 28 is closed, enabling indicator light 30, a light emitting diode, to emit visible radiation. The diagram of FIG. 7 is intended to be substantially representational and not necessarily functional in every respect.

FIG. 7 depicts a condition of the circuit wherein the power lock has been engaged and the indicator switch 28 makes contact. However, it is obvious that when the solenoid is thrown downward, as viewed from the front of FIG. 7, and as depicted by FIG. 5, by reversing current flow in the solenoid 16, switch 28 becomes open and LED 30 emits no radiation, indicating an unlocked power lock condition.

FIG. 5 illustrates the child safety lock device combined with the mechanical functional element of the power lock comprising a solenoid or motor 16, within which there is, in the case of a solenoid, a plunger or core 21. Element 17 of FIG. 5 shows the part of the linkage that is directly attached to the inside door handle and moves in the direction indicated by the arrow when an attempt is made to open the door. Element 19 is the lever part of the latch which protrudes from the face of the door jamb. Element 19 is the currently used manual means for selecting the on and off modes of the child safety locking device. Element 15 of FIG. 5 is part of the conventional door locing apparatus.

FIG. 6 depicts the power locking device and the child safety locking device in the condition of engagement. Linkage 17 has been displaced through a small angular distance in a clockwise direction from that shown in FIG. 5, and the solenoid plunger 21 has forced lever 19 into the child safety lock engaged position. The position of element 17 represents the limit of movement of the safety lock link in the engaged condition. The door cannot be opened from the inside until the child safety lock is disengaged. Note in FIG. 6 That the portion of the linkage 19 that protrudes through the door facing the jamb also rotates, indicating the status of the child safety lock. Manual disengagement of the device is still an available option from the door face and any change made from this location will be indicated on the safety lock display located within the driver's side instrument cluster.

In respect to the actual operation of the power locking system as a whole, reference can be made to FIG. 8, which is a flow chart comprising both operator decisions regarding choices to be made in engaging and disengaging the control system, and step-wise changes in the physical condition of various switches, indicators and mechanical parts. It is to be understood that the present invention is not limited to the sole embodiment described above, but encompasses any and all embodiments within the scope of the following claims.

1. An operational system to control child safety locks on automobiles, comprising:
a) child safety locks, which prevents the rear doors of automobiles from being opened from the the inside when the child safety locks are engaged, see items 17 and 19 in FIG. 6 of drawings, which depicts child safety locks.
b) an electric motor, such as a solenoid, to move the child safety locks into the engaged or disengaged position.
c) an electronic display system, such as a light emitting diode, to indicate the status of the child safety lock mechanism, to show whether the child safety locks are engaged or disengaged.
e) circuit wires.
f) an electric motor is attached to each child safety lock, one end of the circuit wires is attached to each electric motor, the other end of the circuit wire is attached to the rocker arm switch.
